(19) United States
(12) Patent Application Publication
(10) Pub. No.: US 2024/0127324 A1
(43) Pub. Date: Apr. 18, 2024

(54) SYSTEM AND METHOD TO EVOLVE ECOMMERCE TO THE NEXT GENERATION

(71) Applicant: Ramakrishna J. Tumuluri, Hyderabad (IN)

(72) Inventor: Ramakrishna J. Tumuluri, Hyderabad (IN)

(21) Appl. No.: 17/004,030

(22) Filed: Aug. 27, 2020

(51) Int. Cl. G06Q 30/0601; G06Q 50/18; G06T 17/20; G06T 19/20; H04L 9/32

(52) U.S. Cl. CPC G06Q 30/0643; G06Q 30/0625; G06Q 50/184; G06T 17/20; G06T 19/20; H04L 9/3268; G06T 2200/24; G06T 2219/2008

(57) ABSTRACT

The present invention discloses a system and method to evolve e-commerce to the next generation enabling shoppers to search, configure and collaborate during the process of shopping by leveraging 3D models of sale-items. The system enables e-commerce vendors with novel transactions with specialized tools enabling composition of larger entities such as a room, garden, photographs, residential area, etc. from smaller entities like furniture, lights, plants, etc. This composition is enabled from a plurality of e-commerce sites. The system further enables protection of 3D assets on the public world-wide-web with a novel digital rights management solution. A shopping experience that blends the best of online and offline experiences is offered by another embodiment of the present invention viz. 3D & Video Collaboration. Various 3D and Video capable devices such as personal computers, smartphones and tablets are supported. In yet another embodiment the system enables users to composite their personal spaces by uploading pictures of their space which are re-constructed into 3D digital-twins, allowing the user to composite it using 3D sale-items as described earlier.

### FIELD OF THE INVENTION

The invention relates in general to computer network implemented system and method evolving e-commerce to the next generation, in particular, a system enabling novel experiences for shoppers through a plurality of e-commerce sites, by enabling searching, compositing, customizing, collaborating with 3D models of sale-items. The present system is also about enabling rich real-time collaborative experiences between shoppers, merchants through 3D models and video. It is also about protecting 3D assets and controlling their usage by novel “digital rights management” system.

### BACKGROUND OF THE INVENTION

Online shopping has become the new norm, particularly, in the times of pandemic, when people are thinking about stepping out even for shopping essentials. Most of the daily requirements such as groceries, vegetables, dairy products, clothes, accessories, electronics, furniture, etc. are purchased through online shopping by almost 60% of the population. However, many people still prefer to go with the conventional shopping so that they can see the product, try out and check before they invest money. Hence, there is a need for an e-commerce system which enables the customer to visualize the products in real environment to trigger his/her intuitive decision to purchase the products.

Number of efforts have been made to address the visualization effects on the internet by way of virtual reality using advanced technologies. Present systems provide mainly rational selection process with limited parameters such as price, colour, size, etc. They hardly derive aesthetic values of products, especially visually aesthetics while shopping electronically. Further, there are no provisions in the present system where the customers can match the product with his/her inner taste as the customers are facilitated to match the products with the intended environment.

### OBJECTS OF THE INVENTION

The main object of the present invention is to provide a system and method to evolve e-commerce to the next generation for shoppers and merchants by leveraging fundamental technological developments in 3D technology, real time communications, search and novel scheme for protecting 3D assets on the open web.

Accordingly, one of the prime objects of the present invention is to provide a system and method enabling the users to shop products of his/her choice through a plurality of e-commerce sites in a well-protected network.

Another object of the present invention is to provide a system and method enabling the users to compose a 3D entity from smaller entities from a plurality of e-commerce sites and thereby satisfying a need that is not currently met.

Yet another object of the present invention is to provide a system and method enabling the users to search and select sale-items of their choice through a plurality of e-commerce sites using 3D models as query-inputs.

Still another object of the present invention is to provide a system and method enabling the user to configure attributes and features of the 3D model through local secured network or in collaboration with his/her friend.

Yet another object of the present invention is to provide a system and method of Collaborative experience whereby users interact with a plurality of other users & merchants through 3D models, video chat and conventional chat.

Yet another object of the present invention is to provide a system and method to protect 3D assets developed and deployed by merchants on the open web.

The other objects and preferred embodiments and advantages of the present invention will become more apparent from the following description of the present invention when read in conjunction with the accompanying examples and figures which are not intended to limit scope of the present invention in any manner.

### SUMMARY OF THE INVENTION

The present system enables the user/customer to (i) compose a 3D entity/environment in which the selected product can be tested and checked; (ii) search and select products of his/her choice among a plurality of e-commerce sites; (iii) obtain a 3D model of the selected product to be tried and tested in the 3D entity; (iv) configure attributes and features of the 3D model through local network or in collaboration with his/her friend; (v) interact with the seller through the 3D model, video chat and other conventional chats.

In particular, the present invention provides a system evolving e-commerce to the next generation, the system comprising:
a. an input module, enabled to receive a query-based input from a buyer related to each of plurality of purchase item of at least one seller;
b. a processing module, enabled to search the received query-based input related to each of plurality of purchase item and determine a 3D model of each of plurality of purchase item;
c. a 3D model driven query-based database module, enabled to store and query the determined 3D model of each of the plurality of purchase item;
d. a digital rights management module, enabled to protect and control usage of 3D assets via cryptography and license management;
e. a composition module, enabled to compose a 3D model of a space with each of the plurality of 3D model of the purchase item;
f. a configuration module, enabled to customize at least one attribute of each of the plurality of 3D model of the purchase item or 3D model of the space by a 3D input; and
g. a collaboration module enabled to facilitate the collaboration of 3D models between the buyer and the at least one seller in real time along with video collaboration and chat.

In other words, the present system provides a novel collaborative and secured experience for both buyers and sellers involved in shopping transactions enabling buyers to search through a plurality of e-commerce sites through a query-based input wherein the input can be in text, images or 3D model; to shop from a plurality of e-commerce sites; to obtain 3D models of the selected purchase items, if not readily available with the e-commerce sites, then allows them to re-construct 3D models of the purchase items instantly. It further allows protection of 3D assets of the sellers on the public web with a unique digital rights management solution, and compose 3D entities from smaller entities like purchasing items to larger entities such as a room, garden, photographs, residential area, etc. The users can also configure such composed 3D entities by modifying the colour, texture and other features and collaborate with their friends and family in purchasing an item in addition to collaborating with sellers through 3D models in real time.

### BRIEF DESCRIPTION OF THE DRAWINGS

The invention is further described in the detailed description that follows, by reference to the noted drawings by way of illustrative embodiments of the invention, in which like reference numerals represent similar parts throughout the drawings. The invention is not limited to the precise arrangements and illustrative examples shown in the drawings:

FIG. 1 shows the overview of the constituent modules of the eCommerce Next Generation system.

FIG. 2 illustrates an embodiment of the present system wherein a user composes a 3D environment with the 3D model of the product selected from a plurality of e-commerce sites.

FIG. 3, FIG. 4 and FIG. 5 illustrate the system wherein user selects a specific product from each of the multiple e-commerce sites and tries them in his/her living room model demonstrating composition capability.

FIG. 6 illustrates a process of modification of “materials” of a 3D model/entity.

FIG. 7 shows the architecture of the technical details of the import operation of a 3D model in glTF/X3D of the item/product from the e-commerce site (in HTML5) into the compositing “3D model”.

FIG. 8 describes the insertion of the imported 3D-model into the “3D Scene Graph” of the compositing model maintained by the composition module of the present invention.

FIG. 9 illustrates the embellishments made to the imported object after importing in to the 3D model, enabling the newly imported object to be selected and transformed.

FIG. 10 describes the process by which a user obtains a digital-certificate from a Certificate Authority and registers with a License-Server within the Digital Rights Management (DRM) module.

FIG. 11 describes the scenario of production, encryption and distribution of 3D content along with the process in which an end-user requests a license for use of this 3D content.

FIG. 12 illustrates production pipeline of a 3D asset (in glTF or X3D) using reconstruction, material-adjustment, compression within the reconstruction module.

FIG. 13 illustrates process of 3D model driven query in the database module.

FIG. 14 illustrates derived queryable primitives in the database module for a “sofa” as the query input in the form of a “3D model”.

FIG. 15 describes the primitives deriving engine, a critical component of the “model-driven-query” of the database module.

FIG. 16 shows the contents of a sample glTF file in JSON format, an enabler to the “model-driven-query” in the database module.

FIG. 17 shows the overall architecture of the commerce crawler, an integral component of eCommerceNexGen system that helps shoppers find ecommerce sites hosting 3D models of interest.

FIG. 18 illustrates a scheme for model driven query and textual query for an XML/JSON database 1801 storing 3D models of sales-items and products in X3D and glTF format.

FIG. 19 shows the glTF specification in JSON describing materials, in particular, gold.

FIG. 20 illustrates process of configuring the 3D model of the selected sales-item/products in “solo” or “collaboration” modes.

FIG. 20a illustrates the process of changing appearance of the chair in the stack of “web-browser”, “Javascript engine”, “threejs engine” and the “model-viewer” web component.

FIG. 21 illustrates the situation where the environment such as ambient lighting affects the 3D-model of a woman in the context of her makeup.

FIG. 22 illustrates a collaboration experience 2201 offered using a combination of 3D technology, chat and video chat.

FIG. 23 demonstrates the architecture of 3D-Collaboration using Jabber-rpc alongwith WebRTC for Video Chat FIG. 24 demonstrates a “change color” request issued at one end of a Collaboration system and its encoding using jabber-rpc and the corresponding jabber-response, which is “true” in this case.

FIG. 25 demonstrates a system where a user submits pictures taken with an ordinary smart-phone camera or DSLR camera to the eCommerceNexGen system which re-constructs a scale-accurate 3D model using AI & 3D technologies.

### DETAILED DESCRIPTION OF THE PREFERRED EMBODIMENTS

Detailed embodiments of the present invention are disclosed herein with reference to the drawings. However, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention discloses a system for enabling a customized experience wherein the system comprises of: an input module module, enabled to receive a query-based input from a buyer related to each of plurality of purchase item of at least one seller; a processing module, enabled to search the received query-based input related to each of plurality of purchase item and determine a 3D model of each of plurality of purchase item; a 3D model driven query-based database module, enabled to store and query the determined 3D model of each of the plurality of purchase item; a composition module, enabled to compose a 3D model of a space with each of the plurality of 3D model of the purchase item; a configuration module, enabled to customize at least one attribute of each of the plurality of 3D model of the purchase item or 3D model of the space by a 3D input; and a collaboration module enabled to facilitate the communication and collaboration of 3D models between the buyer and the at least one seller in real time. The present invention also enables protection of 3D Assets in a “Digital Rights Management” style whereby assets are cryptographically encrypted and provided to users on specific licensing terms.

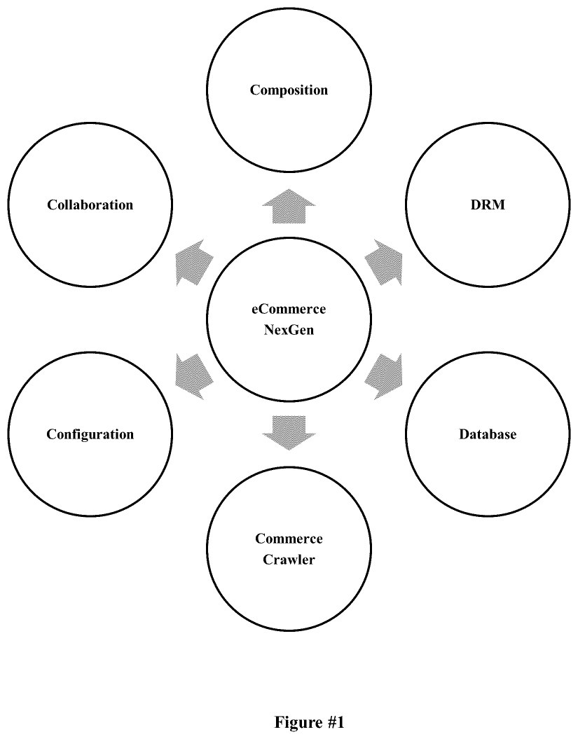

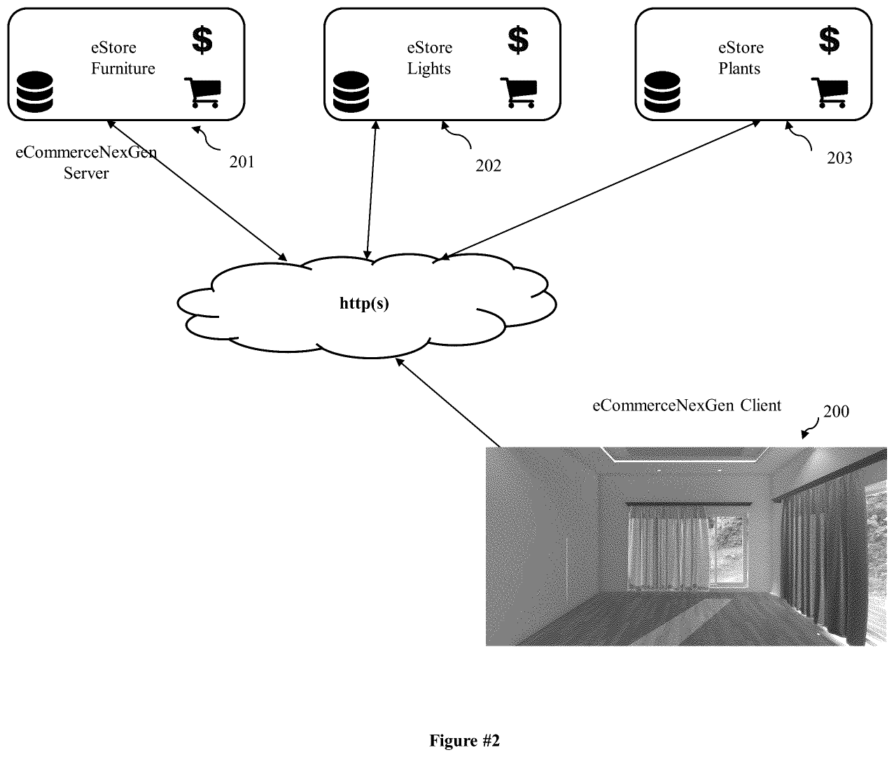

The invention which encompasses different features/modules provides a novel and unique eCommerce system with a blended experience of “online” and “offline” for the user. It also protects assets developed and deployed by eCommerce vendors. FIG. 1 shows the “eCommerce Next Generation” system with its constituent modules. Before selecting a product, the present system enables the user to compose 3D entity/environment in which the selected product can be tested and checked through a composition module. Such 3D entities can be living rooms, houses, 3D photographs of the user, office space, garden, etc. The user/buyer then searches and selects products like furniture, cosmetics, decors, paints, tiles, housing products, etc. of his/her choice, and is enabled to have an interactive buying experience. The user searches for the products which he/she would like to buy among a plurality of e-commerce sites through commerce-module of the system. The resulted/obtained 3D model of the selected product is tried in a 3D environment/template such as living room, garden, kitchen, make-up room, etc.

Further, the system enables the user to configure attributes and features of the 3D model through local network or in collaboration with his/her friend through configuration module. The system also enables the user to interact with a plurality of sellers through the 3D model, video chat and other conventional chats through collaboration module. The whole search, composition and configuration of the 3D model happens in a protected environment as provided by the DRM module of the present system. Detailed embodiments of the present invention are disclosed herein with reference to the drawings.

Composition Module:

Composition is the process of composing a large entity such as the interiors of a room, architecture of a building, 3D model of a person, etc. In particular, if a user intends to purchase certain furniture, fixtures, decorative items, lamps for his/her living room, the composition module helps in composing a similar living room as a 3D interactive entity and to try out such selected products/items in the said 3D entity before purchasing those produces/items. Accordingly, one of the embodiments of the present invention illustrates how a user selects/shops for products for designing a room. To design the interiors of a living room, a user visits several e-commerce sites and picks items to compose the living room. For instance, a floor lamp may be added from an e-commerce site selling lamps and lights. The user may also be interested in purchasing and composing the living room with items like furniture such as sofas, coffee table, book shelf, etc. from another e-commerce site; and indoor plants from yet another e-Commerce site, which is accomplished as follows.

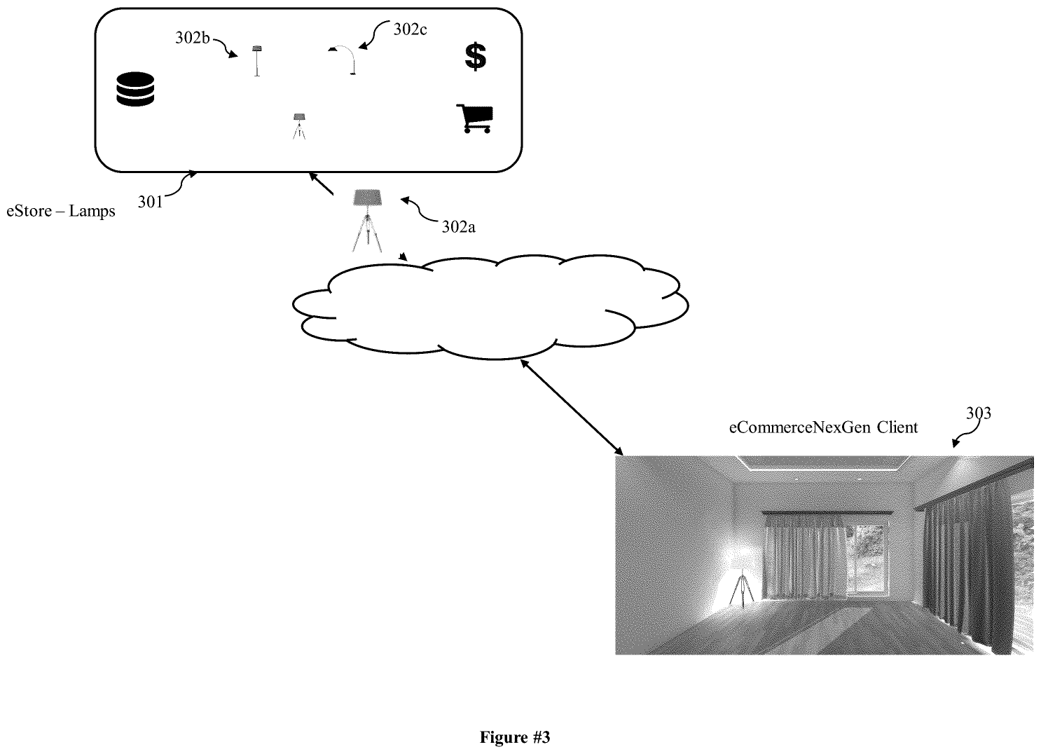

FIG. 2 illustrates the scenario of a user using multiple e-commerce sites, in particular, three sites to design his/her living room 200 wherein the first e-commerce site 201 sells furniture, the second site 202 sells lights and lamps, and the third site 203 sells plants (indoor & outdoor) and gardening items. User's living room 3D-model 200 as readily available in the present system or which can be created/composed by the system based on the inputs provided by the user is empty as shown. The said living room model 200 runs natively on platforms like Windows, iOS, Android or WebGL. It is built using a 3D engine such as Unity, Unreal, jMonkeyEngine, etc. E-commerce sites host 3D models in formats glTF or X3D models, which are internet & web standards. Please refer to the reference section for relevant URLs.

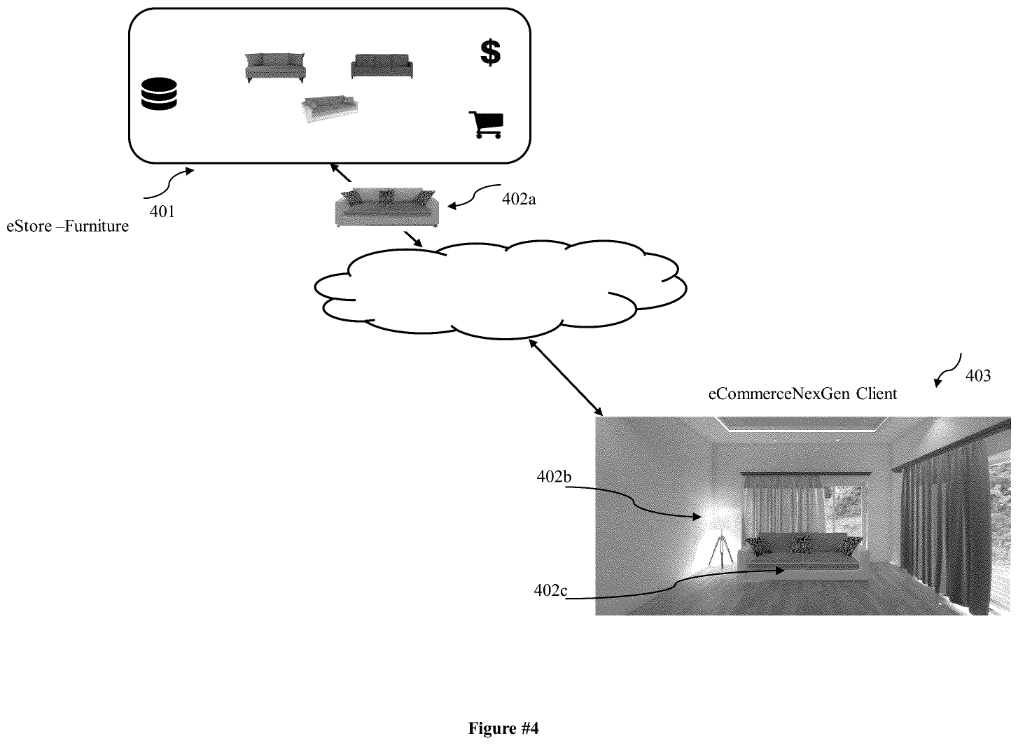

FIG. 3 illustrates the system 300 wherein user selects a specific lamp 302a from an e-commerce site 301 selling multiple lights and lamps 302b, 302c, etc. and drag-drops it into his/her living room model 303. The dropped lamp 302a is visible and has many controls provided by the system such as on/off, intensity control, color control, etc. The lamp 302a can be placed anywhere in the room 303 using transform controls such as ‘move’, ‘rotate’, etc.

FIG. 4 illustrates the user selects a sofa 402a that he/she likes from another e-commerce site/store 401 and drag-drops it into his/her living room model 403. Once again transform controls such as ‘Move’, ‘Rotate’, ‘Select’, ‘Render’, etc. are used to place the sofa 402a in exactly the location and direction that the user chooses. The composition module enables interaction of the light provided by the lamp 402b, ambient-light etc. with the new sofa 402c is possible, which is normally not possible for single sale-item purchases.

FIG. 5 illustrates the user selecting an indoor plant 502a from yet another e-commerce site 501, dragging-dropping it into the living room model 503 to enhance the interiors of the said living room. Transform controls such as ‘move’, ‘rotate’, etc. are also deployed for accurate placement and orientation of the indoor plant 502a. The composition module enables the user to “try” sale-items in how they fit together in his/her living room before purchasing leading to satisfaction and reducing returns thereby helping merchants.

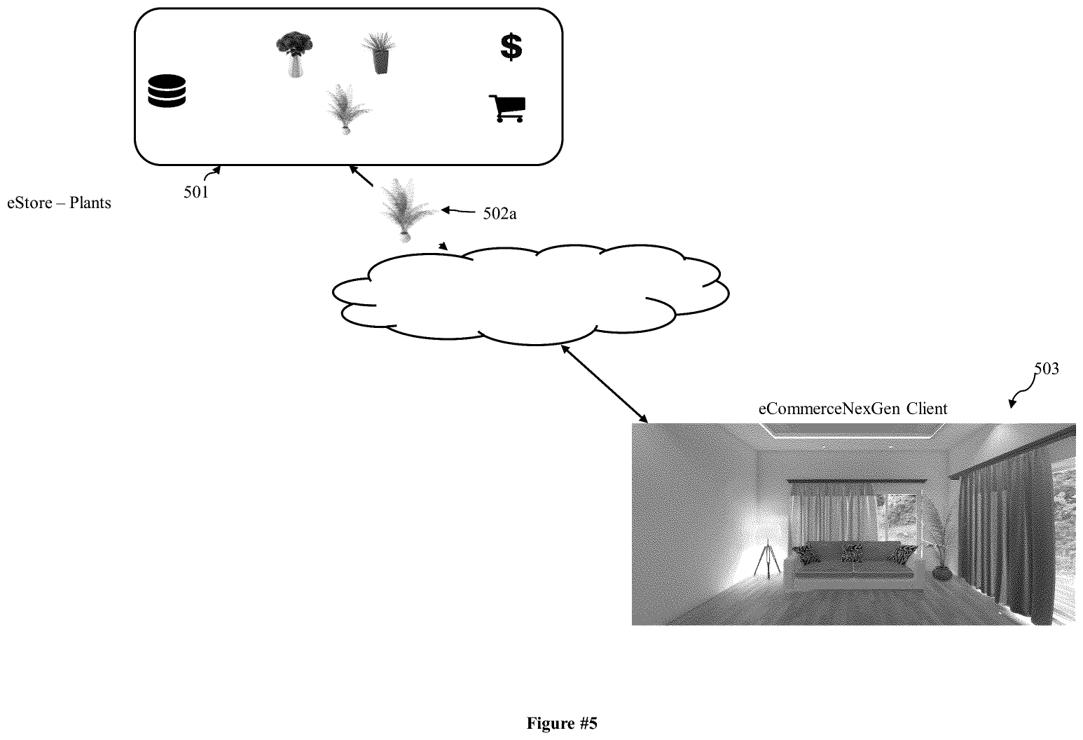

The process of modification of various 3D sub-models (also called objects) in any of the 3D model/entity, in particular, a living room model 601 is illustrated in FIG. 6. In this illustrative example as provided in FIG. 6, the process of modifying the tile texture and paint colors of the living room 601 is detailed. Paint palette 602 offers many colors and textures that can be applied to the walls. It is accomplished by changing the material of the walls 601 of the living room model to a new material. Similarly, material can be changed in the tiles 602 used in the living room model 601 chosen from the tile pallete 603 as available in the system. This material will reflect the base color, metallic roughness and other factors described by the PBR standard of glTF and X3D. Under the composition module, a target object (wall, floor etc.) is identified by calculating from the screen-position and then programmatically the selected new material is applied. Once again, the composition module enables the shopper to “try” tiles, paints in combination with “lights”, “furniture” etc.

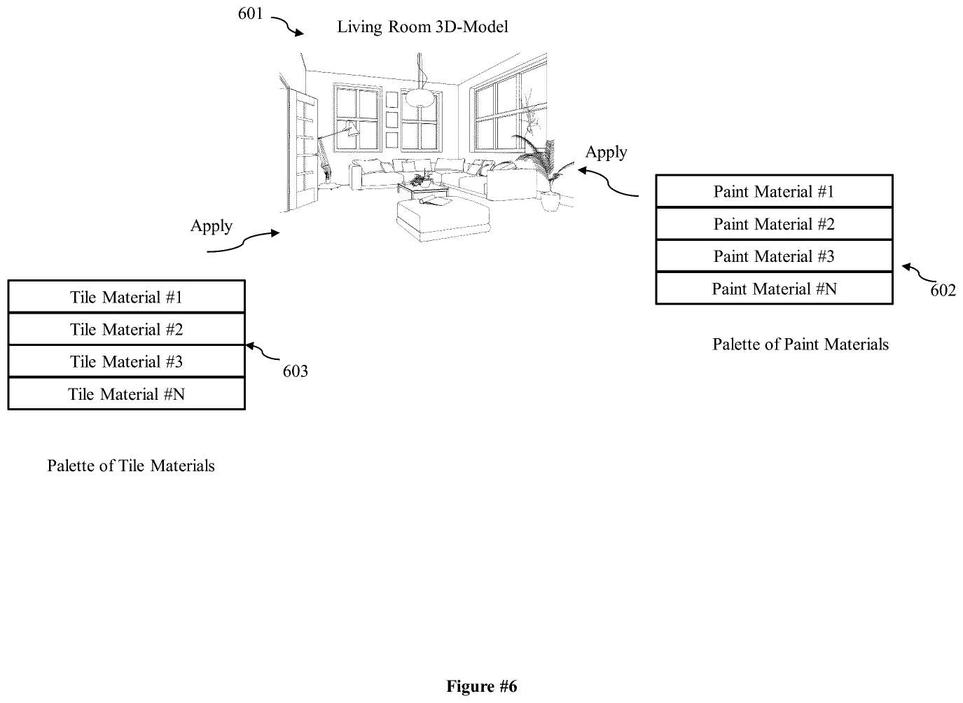

The technical details of the import operation of a 3D model of the item/product from the e-commerce site 701 in HTML5 into the living room model can be seen in FIG. 7. This site 701 sells lamps of various sizes, shapes and light types 703a, 703b, 703c, etc. These lamps are described by 3D models in the glTF format or X3D format, which enable description of geometry, material and light details such as point light, spot light, direction light, their intensity, range, etc. The details are as permitted under the specifications of glTF and/or X3D. These 3D-models of the items of products available in the e-commerce site 701 are rendered by engines such as those offered by Google's model-viewer web-component (model-viewer.js) or open-source engines such as threejs.org. The user (or shopper) selects a lamp of his/her choice and drag-drops it into a palette 704. The palette is a simple program that can host many 3D-models and images. It is built on top of the operating system (viz. Windows, iOS, Android and WebGL). It is meant to help accumulate assets that are downloaded at leisure and used during designing. Without a palette, the wait times for downloading 3D-models could ruin the user-experience. Once a small subset of objects is accumulated in the palette, the user can import them into the living room model using a special program called Importer 706. This importer 706 can parse glTF/X3D and add them to the SceneGraph hosted by the native “3D Engine” 708, such as Unity, Unreal, jMonkeyEngine, etc. Usually this incorporates adding the imported model as a “node” in the Scene Graph 707 of the living room model, which is illustrated in the forthcoming paragraph in greater detail.

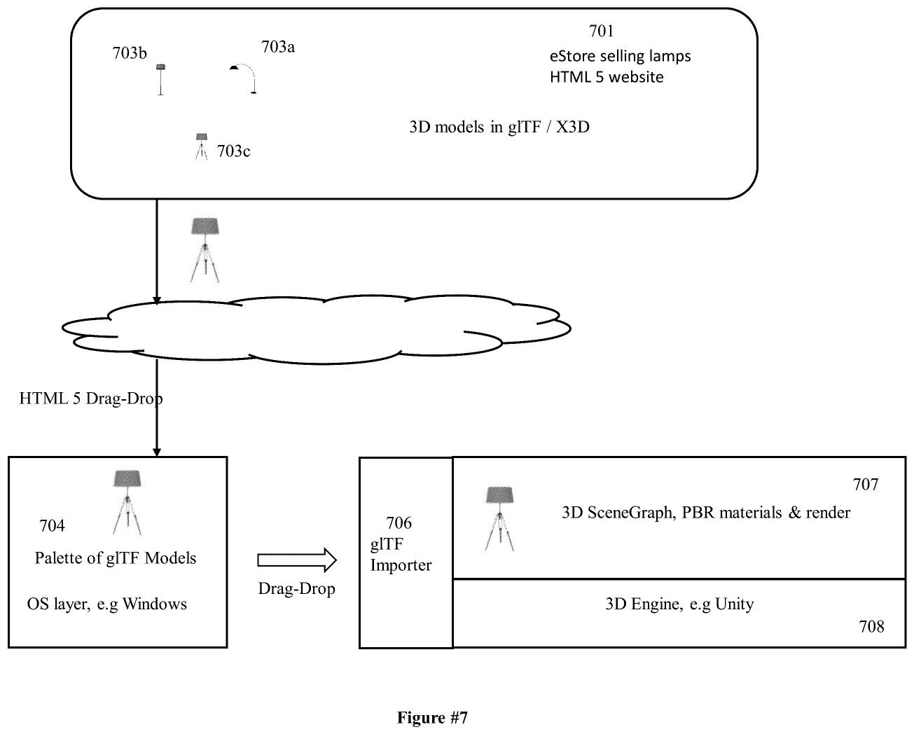

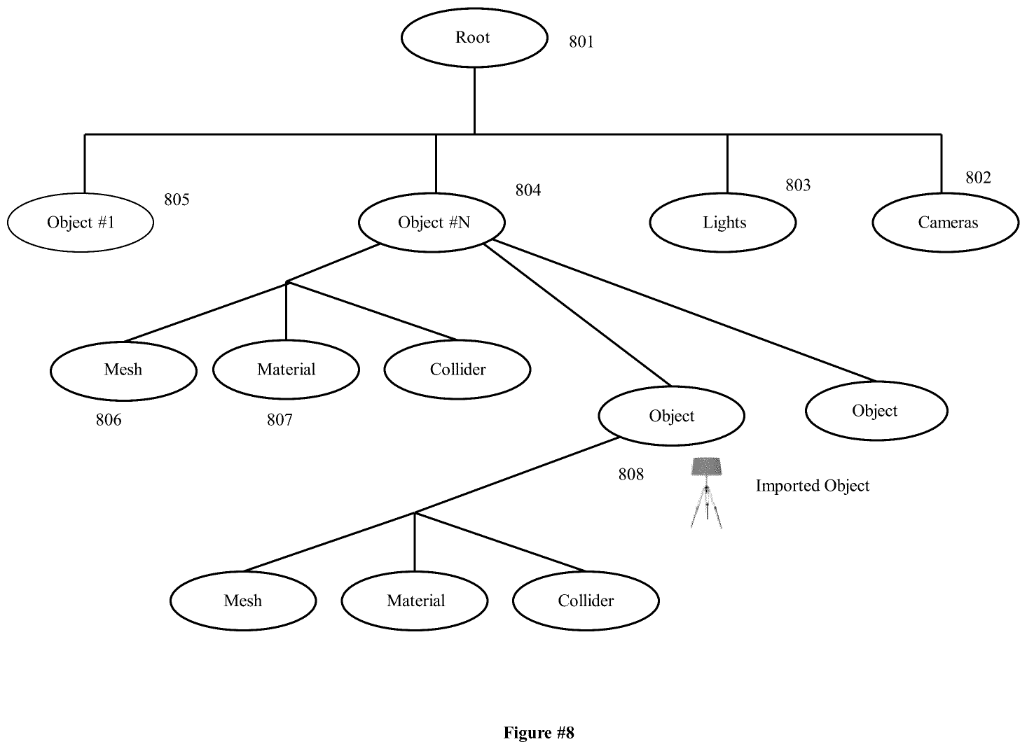

FIG. 8 describes one of the embodiments—the 3D Scene Graph 801 maintained by the composition module of the present invention, in particular, in the living room model. It is a well-accepted 3D Scene Graph with cameras 802, lights 803 and many other nodes 804, 805, etc. Each of these nodes can host an entire Scene Graph although usually it is other grouping nodes, while cameras and lights are centralized. Every node has at least three components although it can be much more. The first mandatory component is a mesh 806 which is a bunch of triangles that represent the shape or geometry of the 3D object. The second mandatory component is material 807. Most modern-day material descriptions follow the guidelines, namely Physically Based Rendering (PBR) Guidelines. The composition module of the present system follows all these well-developed standards. The importer takes a glTF scene and adds it as a node 808 in the living room model, after which the user uses the navigation controls to navigate within the scene (viz. zoom, pan and rotate). Further object-level controls are used to place and orient (viz. move, rotate, scale) the imported 3D object.

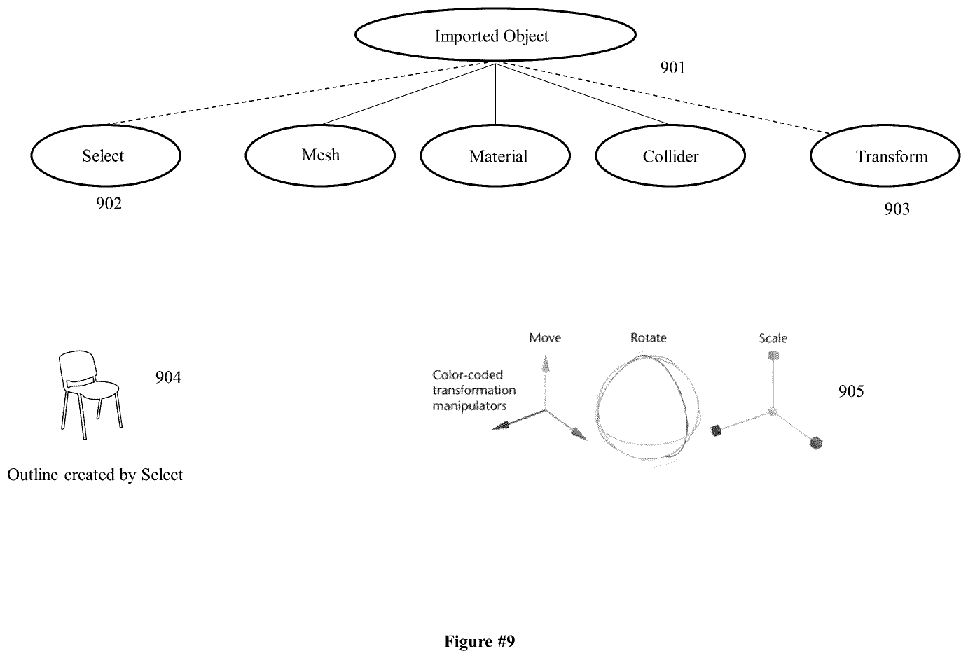

FIG. 9 illustrates the embellishments 901 made to the imported object after importing in to the living room model, enabling the newly imported object to be selected and transformed. Specifically, on a select operation 902, an outline is developed using a special shader. A shader is a special program written in a specific language such as HLSL or GLSL to produce outline of the imported model as shown as 904. Please see reference for further details. A special program is also attached to the newly imported object to enable transforms 903. These transforms enable move, rotate and scale operations. The transform 903 enabling program enables the imported-object to be identified by an input device such as a mouse and transform Gizmos 905 to be attached. Gizmos are graphical controls that enable the user to easily perform transform operations. Controls are also attached to lights to enable controlling on/off, intensity, etc. Controls are also attached to animated objects to control animation such as on/off, speed, etc. For instance, to show opening of a door of a cabinet via animation.

DRM Module:

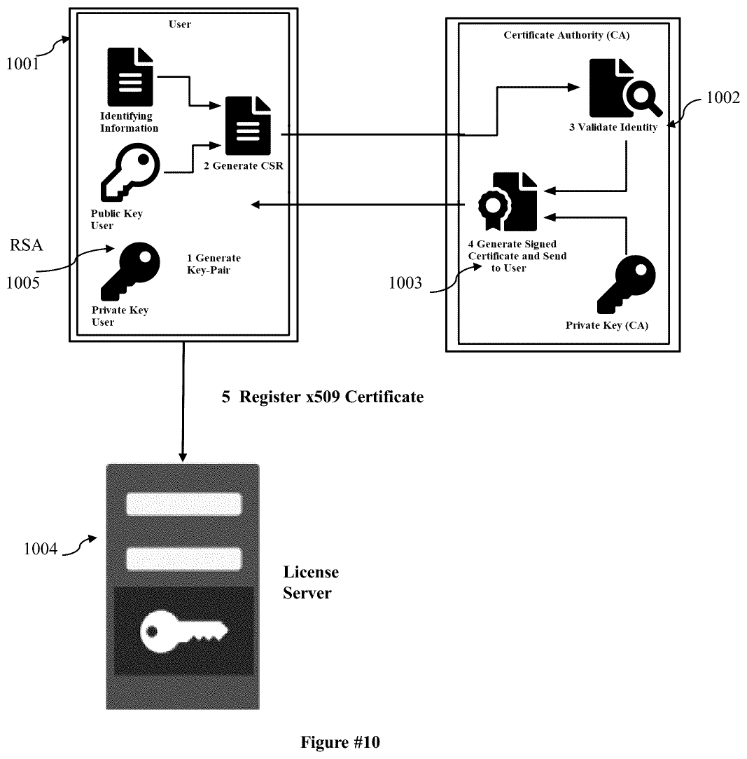

In order to enable the user to experience the present next generation shopping in a protected environment, the present system discloses another embodiment called Digital Rights Management (DRM) module. This aspect of the present invention provides a novel scheme to protect “3D assets” on the web, particularly in gITF and X3D format. FIG. 10 describes the process by which a user 1001 obtains an x509 digital-certificate 1003 from a Certificate Authority (CA) 1002 and registers with a License-Server 1004. Many websites continue to use the username-password mechanism for user-authentication. Some have adopted a two-factor authentication such as sending a One Time Password (OTP) to the registered user's mobile phone in addition to the username-password authentication mechanism. In this embodiment under DRM scheme, a cryptographic method for authenticating a user 1001 is disclosed. Firstly, a user 1001 generates a key-pair using a public-key algorithm like RSA 1005. This is usually done via a web-form from the CA 1002. An example of a CA is ‘Digicert’. CA can also be run by the e-commerce company optionally. In the next step, the user 1001 submits his/her public-key along with identifying information (viz. address, social-security number, etc.) to the CA 1002 in the form of Certificate Signing Request (CSR). The CA 1002 then validates the CSR through many verifications (viz. verifying address to credit-check etc. depending upon the CA). After satisfying itself of the authenticity of information provided in the CSR, the CA 1002 issues a Digital Certificate in the format of an x509 certificate to the user 1001. This x509 certificate 1003 can be cryptographically checked as proof of client authentication by many web-sites and e-commerce sites that typically run the protocol ‘https’ with ‘Client-Auth’. User 1001 then registers his/her certificate with the License-Server 1004. This License Server 1004 issues licenses authorizing use of the “3D model”. It can be time-bound or controlled in other ways depending upon the e-commerce sites' policies.

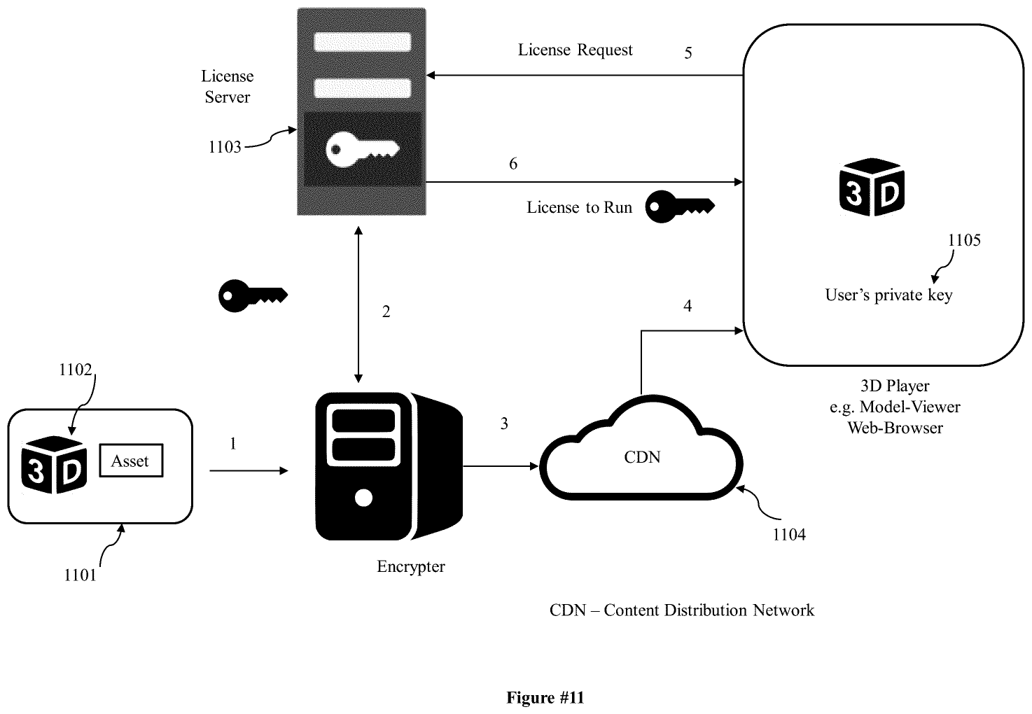

FIG. 11 describes the scenario of production, encryption and distribution of 3D content along with the process in which an end-user requests a license for use of this 3D content. The e-commerce company 1101 encrypts the content 1102 using well established symmetric-ciphers such as AES (Advanced Encryption Standard). Next, it registers the key used in previous step with the License Server 1103. It then distributes the encrypted 3D content to a Content Distribution Network (CDN) 1104, for example, CloudFlare. A user requests the use of the 3D-Content during shopping on the e-commerce site and requesting to view/interact with the said 3D content. For instance, the 3D model of a sofa that the user is interested in, perhaps to see, how it fits into his living-room etc. Upon receipt of such user's request, it is silently relayed to the License Server 1103. The License Server checks if the end-user has complied with e-commerce site's requirements (viz. paid the fees, accepted legal terms, etc.). Upon compliance by the user, it issues a license response which includes the key to AES encryption employed by the e-commerce site. This key is encrypted using the public-key of the user so that it can be decrypted only by the user's private-key 1105. This is a proven method for public-key crypto-systems such as RSA. Now the user's browser uses this key to decrypt the encrypted 3D model and feeds it to the 3D engine to render (ex. Google's modelviewer.js or threejs or equivalent). So, the “3D Model” is never in the clear. It is always encrypted and is hence protected from theft by anyone from the e-commerce site. In situations where this 3D content is used in a desktop environment (or 3D engines like unity) a similar method is used. 3D content is always in an encrypted-form until it is about to be used by the related 3D engine. This ensures that the 3D Model (asset) has good protection and ensure that folks who invest developing such assets can be assured that their assets will not be stolen easily.

Reconstruction Module:

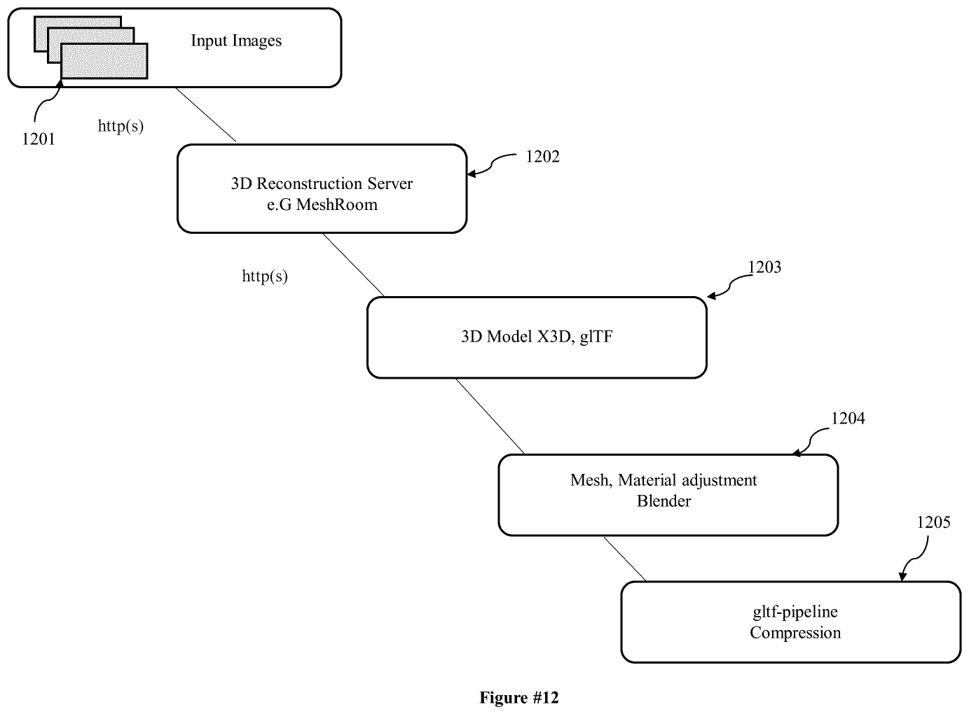

Leveraging the power of artificial intelligence, in particular, computer-vision, a 3D model can be created by using reconstruction techniques. Production of a 3D asset (in glTF or X3D) using a reconstruction-oriented process 1200 is enabled through another embodiment of the present invention. For instance, let us say a 3D asset for a chair is to be developed as in FIG. 12. The physical chair is kept in the center of the room, which is surrounded by white boards. Pictures are taken of this chair (with a SLR camera) from at least 6 different views viz. front, back, left, right, top and bottom, 1201. These pictures 1201 are fed to a 3D reconstruction server 1202 (such as MeshRoom from: http://alicevision.org). This program will create a ‘mesh’ and possibly ‘material’ to go with it in a ‘3D model’ format 1203. This is fed into a sophisticated program like blender 1204 (http://blender.org). In blender, the ‘mesh’ and ‘material’ are adjusted to make it be very close to the real chair visually. Then glTF/X3D models can be exported from blender. These are then fed into tools such as glTF-pipeline (htps://github.com/CesiumGS/gltf-pipeline) to apply compression algorithms such as ‘Draco’ 1205. This will create a finished asset that can be uploaded on the web and rendered by web-browsers using Javascript based engines such as “model-viewer” from Google or threejs from http://www.threejs.org.

Database Module:

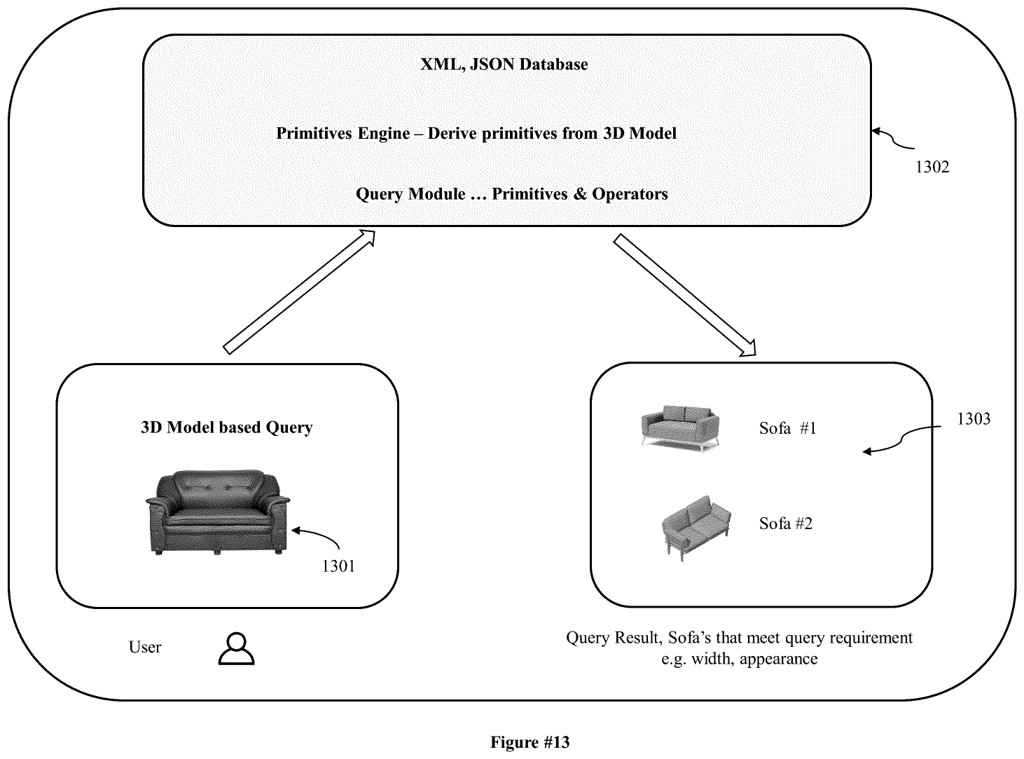

The present invention, vide yet another embodiment of the present invention, enables the user to search 3D models of the products/items of his/her choice among plurality of e-commerce sites. FIG. 13 illustrates the process of model driven query through database module 1300. Generally searches in database and search-engines are carried out by providing a textual string to be used as the query-input. The present embodiment of the disclosed invention includes a method where a 3D model is used as the input 1301. This is possible because the 3D model is described in XML for X3D and JSON for glTF, each of them is textual in nature. XML family of databases have a well-developed query language called XQuery. A user can formulate his/her query in that language and the XML database produces the result by searching a stored, indexed, balanced-tree. glTF uses JSON as the base language. JSON is also textual in nature and there are many implementations of JSON databases including Oracle, MySQL, MongoDB etc. 1302 is an embodiment of XML/JSON database. The query is formulated in SQL/JSON, JSON dot notation or using the find operator. Query output is as shown in 1303

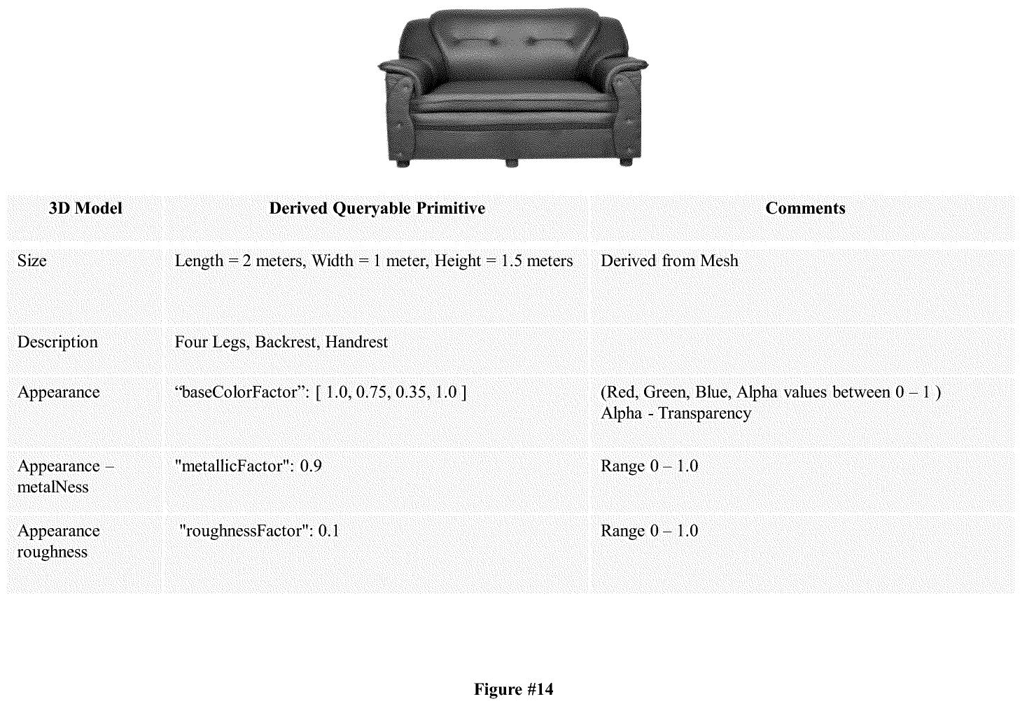

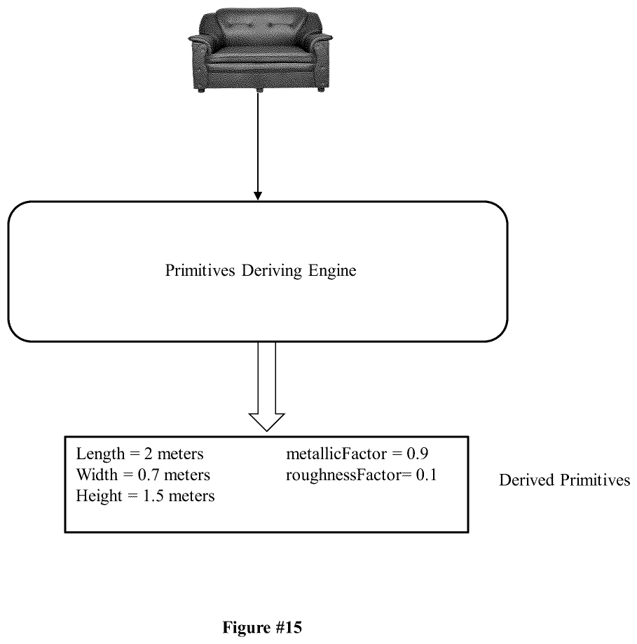

FIG. 14 illustrates deriving queryable primitives form the “3D model” used as input query. Primitives that can be derived are height, width, length, and from appearance of the sofa. Material in glTF and many modern PBR have base color factor, metallic factor and roughness factor used for that, whose range of values are shown in the figure. The actual values from the sofa model are derived and used for query.

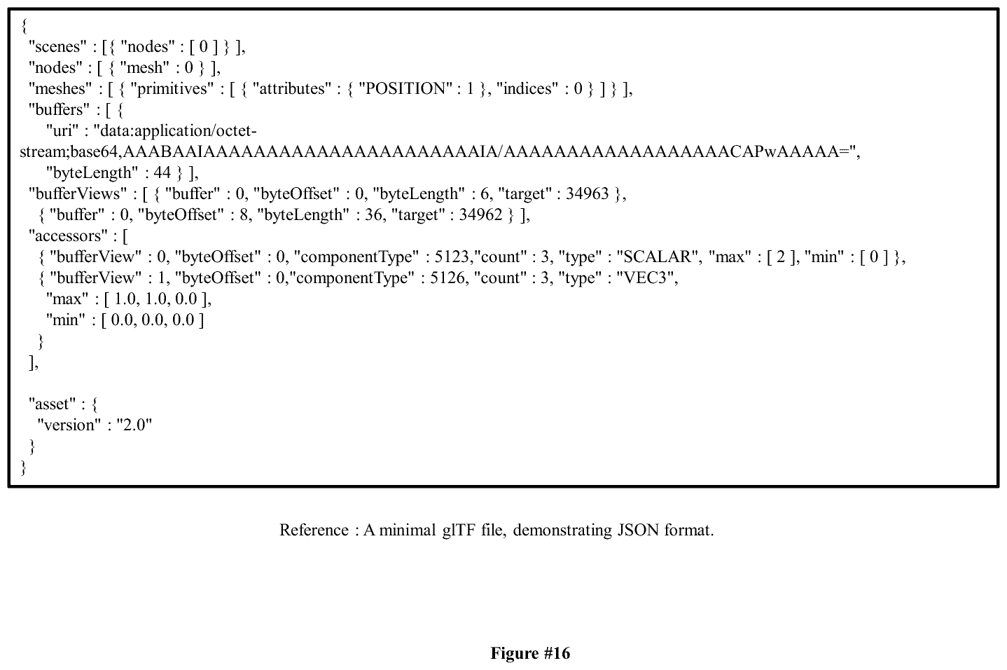

FIG. 15 describes the primitives deriving engine, the main component of the present 3D query driven model. In the case of the illustrated embodiment of a sofa being queries by a use, values of length of 2 meters, width of 0.7 meters, height of 15 meters, metallic factor of 0.9, roughness factor of 0.1 have been derived. These are used along with operators such as “equals”, “and”, “or”, “not” and presented to the user for querying the entire database that consists of many sofas that the specific e-Commerce site holds. A 3D model as the input-query has been transformed into a textual search. Standard JSON query mechanisms of SQL/JSON and ‘Find’ operators are used to query the database. For X3D storage in an XML database, XQuery language is used for querying.

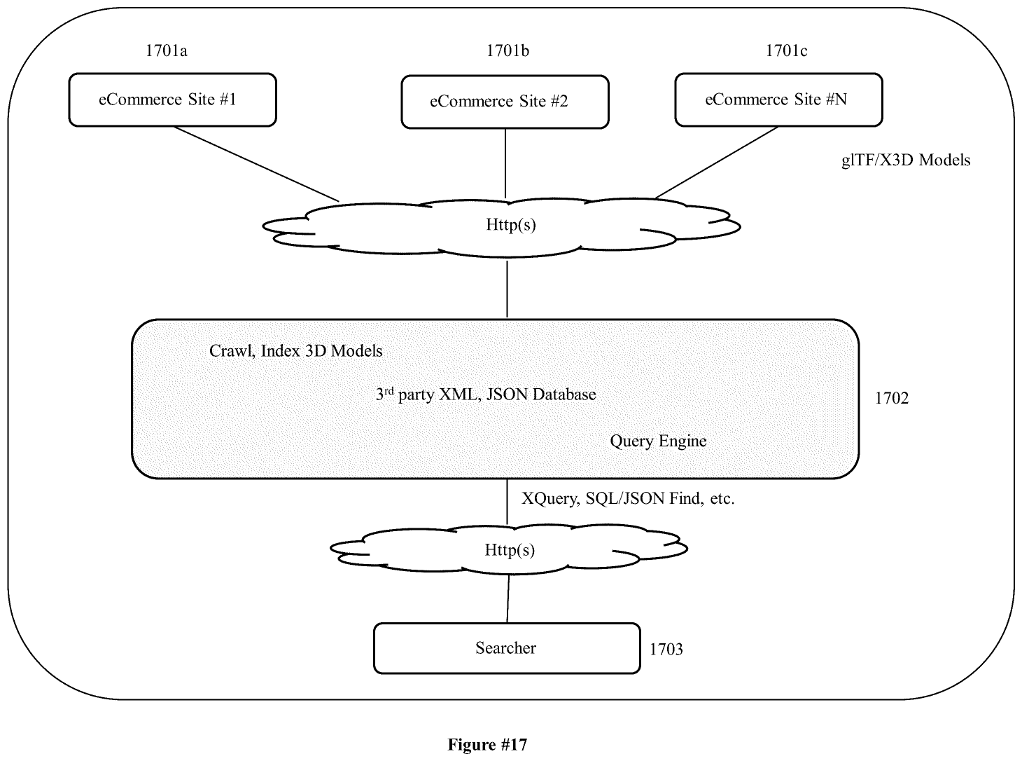

FIG. 16 shows the contents of a sample glTF file in JSON format. The illustrated JSON encoding demonstrates how the primitives deriving engine can derive primitives such as height, length, metallic factor, etc. Please see references for JSON notation wrt glTF.

Commerce Crawler Module:

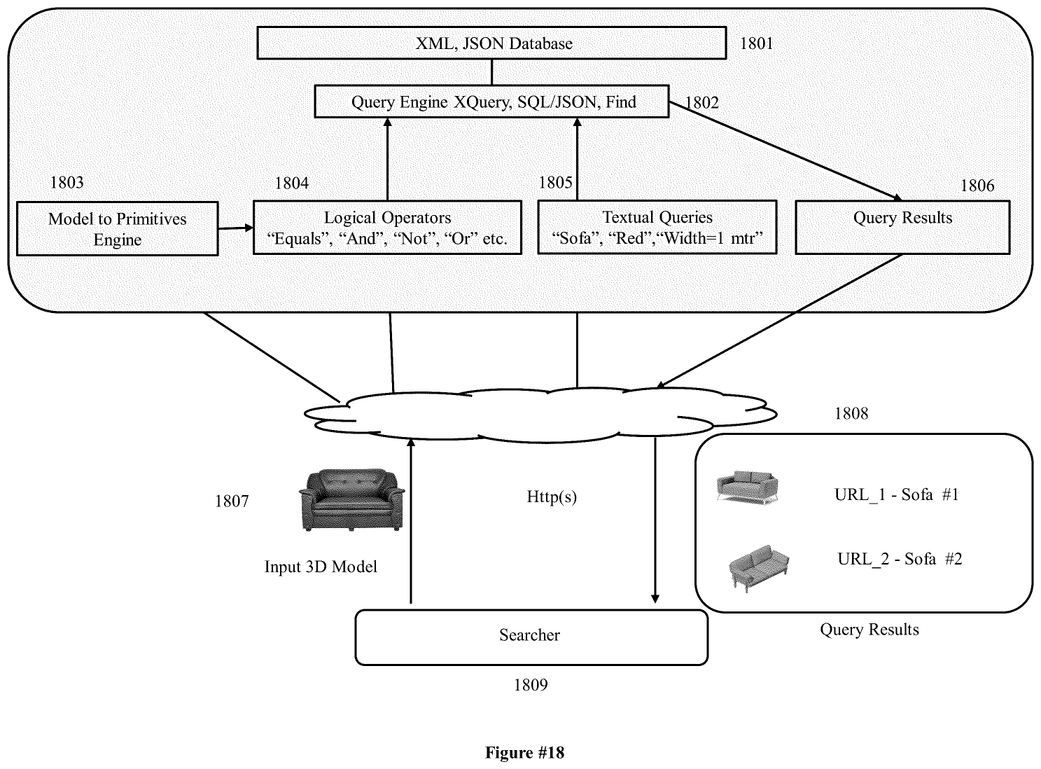

FIG. 17 shows the overall architecture of yet another embodiment of the present invention—the commerce crawler, an integral part of the eCommerceNexGen system. The crawler (including a database and a query engine) 1702 of the present embodiment crawls a plurality of e-Commerce sites 1701a, 1701b . . . 1701n, each of which leverages 3D-Models developed in the X3D and glTF formats. It crawls these sites 1701a, 1701b . . . 1701n based on an initial feed. The crawler 1702 identifies all the 3D-Model based sale-items/products available in the plurality of e-Commerce sites 1701a, 1701b . . . 1701n and indexes them in its database, which supports XML and JSON storage and query. The searcher 1703 is a typical end-user who is searching for sale-items/products of his/her interest among the plurality of e-Commerce sites 1701a, 1701b . . . 1701n. The searches being conducted through this can be textual or model driven, in either of which case 3D searches are enabled. For instance, a textual search may be like ‘Show e-Commerce sites that have red sofa of length 2 meters’. A corresponding model driven search is when the searcher 1703 submits/uploads a 3D model of a red-sofa. The engine will derive the primitives from the 3D model, which primitives can be of length, width, height, Appearance, etc. Appearance is based on the entire specification of the PBR model. Please see reference for PBR materials and PBR rendering in the above paragraphs, in particular, metallic factor, roughness factor, etc.

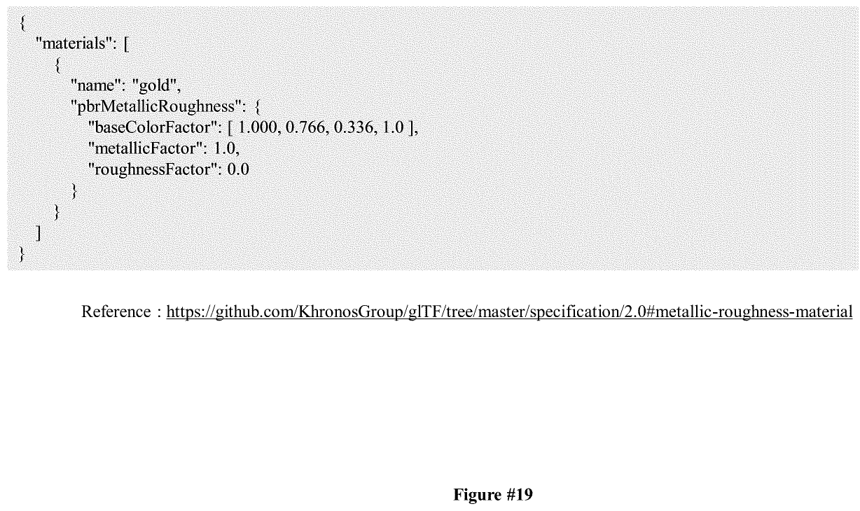

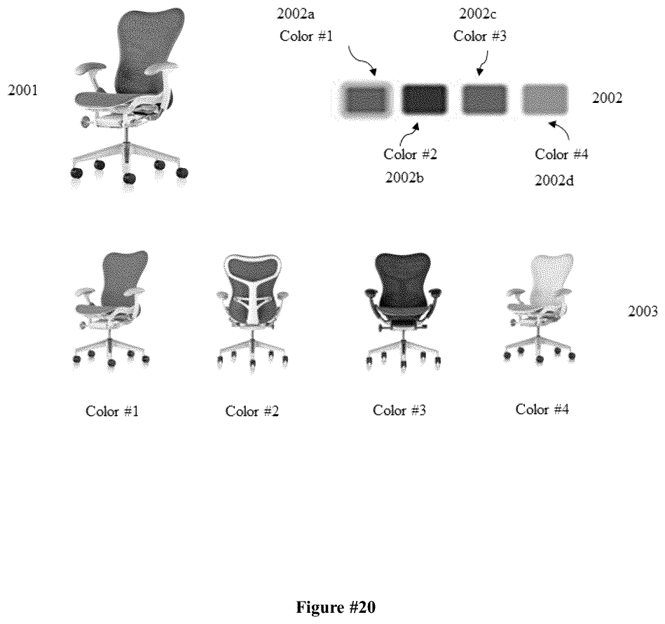

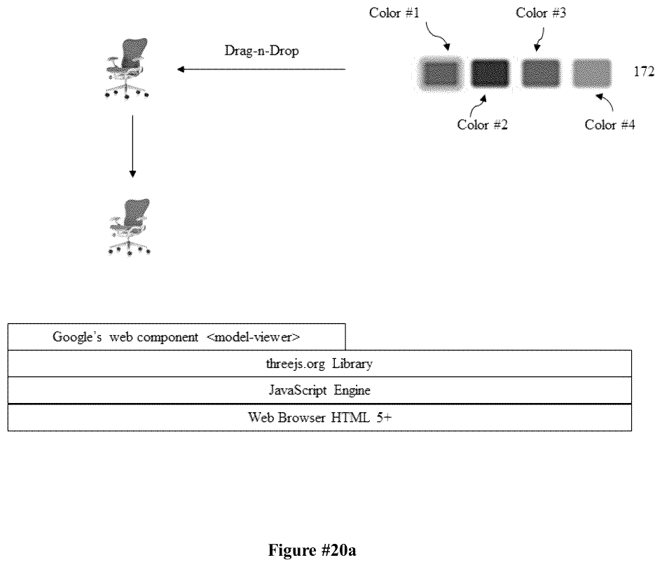

FIG. 18 illustrates a scheme for model driven query and textual query for an XML/JSON database 1801 storing 3D models of sales-items and products in X3D and glTF format. It is to be noted that this is readily possible in databases like Oracle, MySQL, etc. The database 1801 includes a query engine 1802. The novelty of this particular embodiment lies in the processing of the query through model to primitive's engine 1803, usage of operators 1804, usage of textual queries 1805 to obtain the results 1806/1808. Referring to FIG. 18, when a searcher 1809 inputs a 3D model as a query 1807, the primitive's engine 1803 takes a glTF model and processes it for primitives such as width, length, metallic form factor, roughness factor, etc. For instance, width and length are computed from the mesh co-ordinates, with width being the distance between the lowest ‘x’ co-ordinate and highest ‘x’ co-ordinate. Similarly, length, height and depth are the distance between the lowest ‘y’ co-ordinate and highest ‘y’ co-ordinate; and the distance between the lowest ‘z’ co-ordinate and highest ‘z’ co-ordinate respectively. Primitives such as metallic form factor and roughness factor are directly parsed form the glTF model itself as shown in the algorithm provided under FIG. 19.

These primitives are combined with operators 1804 to form queries in XQuery or SQL/JSON, which are fed into the query engine 1802. The results 1806 obtained are packaged up as a glTF/X3D object and returned to the searcher 1809 along with the URL of the e-Commerce site as in 1808.

The processing of textual queries are also in a similar way as above except for the searcher 1809 specifies the query such as ‘width=1 meter’, “metallic form factor=1.0’, etc.

FIG. 19 shows the glTF specification in JSON describing materials, in particular, gold. PBR metallic roughness is used to describe the material gold. Parametric values of base color factor, metallic factor, roughness factor can be stored, indexed and used for queries.

Configuration Module:

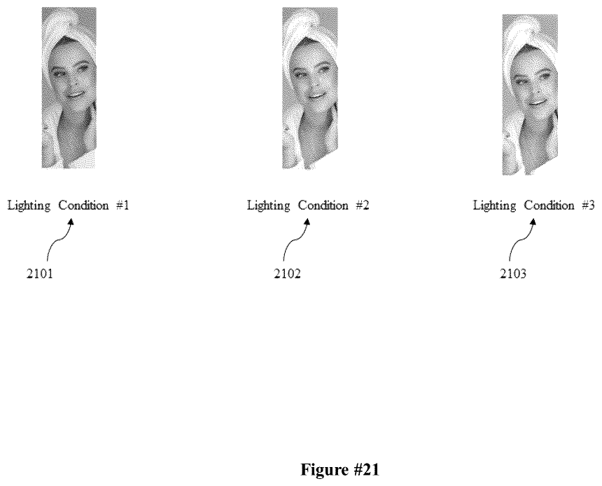

Now that the user has searched the 3D models of the products of his/her choice and composed it in the selected 3D entity for trying out, the present invention provides few more features that helps in configuring, modifying the 3D model of the products to suit his/her interest/taste. Yet another aspect of the present invention is the process of configuring the 3D model of the selected sales-item/products in “solo” or “collaboration” modes. For instance, configuration of a chair viz. change of appearance, color and textures of the chair 2001 is being discussed in FIG. 20. The present module offers various color-options 2002a, 2002b, 2002c and 2002d. Upon selection of a particular color from the options provided, the selected chair 2001 will be modified after application of the selected color as 2003. This happens in the web-browser. The original chair model being in glTF is rendered by a JavaScript based engine. In the sample the chosen engine is Google's “module-viewer” web-component. Please see reference.

The chair 2001 is rendered in the HTML5 web-browser by the glTF engine model-viewer.js and available as a web-component “model-viewer” as follows.
<model-viewer src=“chair.glb”></model-viewer>

In one approach, this is accomplished within a library such as threejs. The “Chair” is loaded by a library called GLTFLoader. The colors are offered as a palette 2002. The user drags a specific color and drops it on the original chair 2001. This causes that color to be applied as a “glTF” material onto the chosen area of the chair. On the change of material an event is triggered and the threejs engine renders the chair again. In this case, the new color is Red 2003.

FIG. 20a describes the “schematic”. This configuration viz. change in “appearance” can be done “solo” or “collaboratively” with one or more persons. The collaboration scheme is described in greater detail in the forthcoming paragraphs. FIG. 20a shows the “Schematic” of the Configuration module. Web-Component “model-viewer” renders a glTF model. Threejs library is to make configuration changes, lighting etc. All of this run on a JavaScript engine in the HTML5 compliant Web-Browser.

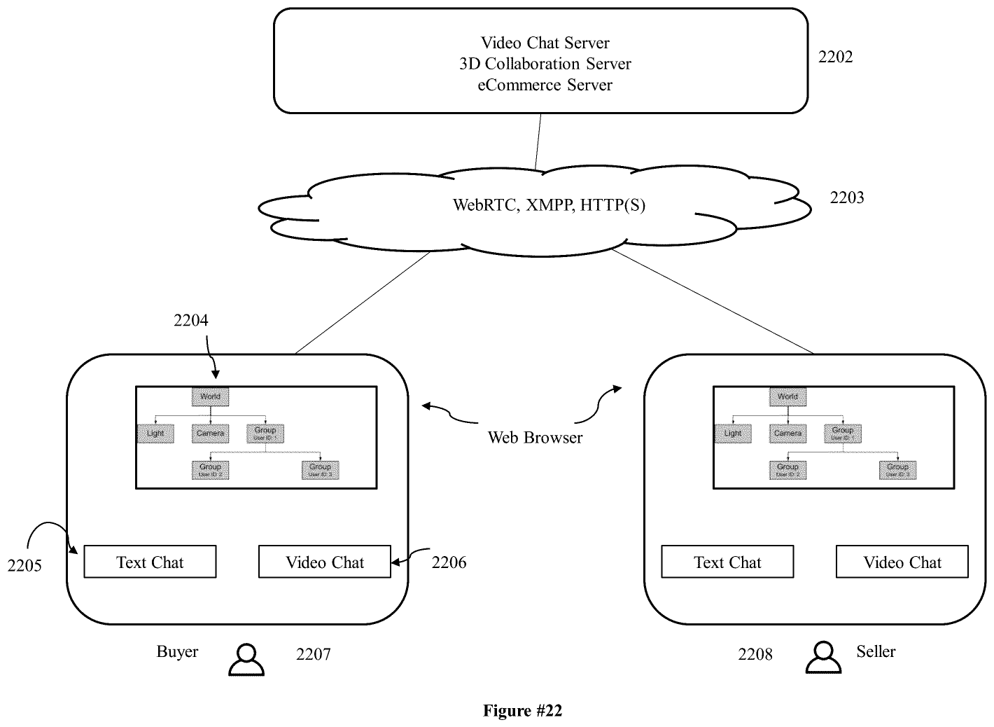

FIG. 21 illustrates the situation where the environment of the 3D environment is changed due to lighting. For instance, the 3D environment/template being explained is a makeup room wherein the change in lighting is accomplished by the addition of one or more lights. The glTF spec has an extension for lights. It supports three different lights viz. spot light, point light and direction light. For configuration module, the effect of “makeup” in different lighting-conditions can be simulated by turning any of these lights on/off, varying their intensity, their color or range to give different effects 2101, 2102 and 2103.

Other controls offered in this module include lighting controls, animation controls and background/environmental controls as allowed by the glTF/X3D specifications. Lighting controls allow scene lights to be controlled with respect to intensity, range, color, etc. based on the users' choices. Under animation control, the doors of a cabinet, pullout of a recliner sofa, etc. can be demonstrated online. These controls/changes in the configuration module can be done by a single user or collaboratively with his/her friends. The collaboration module details the collaboration of 3D models using Jabber-RPC, a component of XMPP. Please see references for further details.

Collaboration Module:

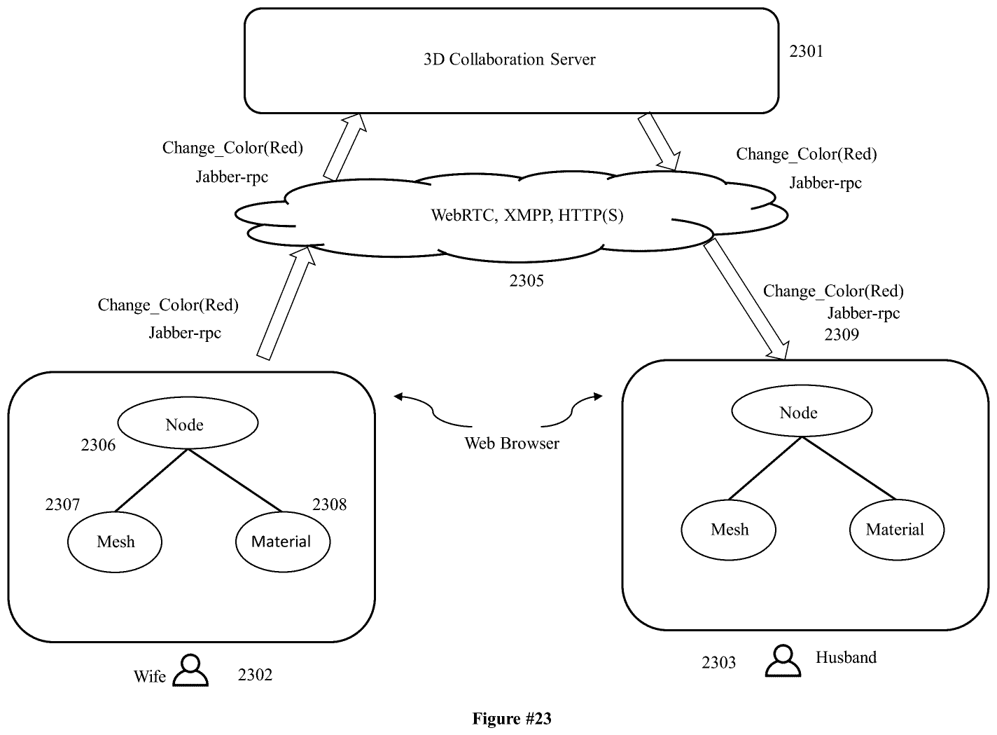

FIG. 22 illustrates a collaboration experience 2201 offered using a combination of 3D technology, chat and video chat. A blended experience of “offline” and “online” is created. A server-combination 2202 is instantiated using “Video Chat Server” such as “jitsi”, a “3D Collaboration” server built on Jabber for glTF/X3D and an e-commerce server such as “Magento”. Please see references for further details. Protocols used 2203 are XMPP, WebRTC and Http. Current e-commerce sites feature “text”, “images” and “video”. The present embodiment adds other options of features such as 3D Model 2204, chat 2205 and video chat 2206 in a novel and collaborative way so as to enable users 2207 to interact with a plurality of sellers 2208 in a collaborative way. The 3D model expressed in glTF or X3D is rendered by a 3D viewer like Google's model-viewer or a 3D library like threejs.org. Chat is powered by proven instant messaging servers like XMPP servers, and Video Chat is powered by WebRTC compliant server such as jitsi.

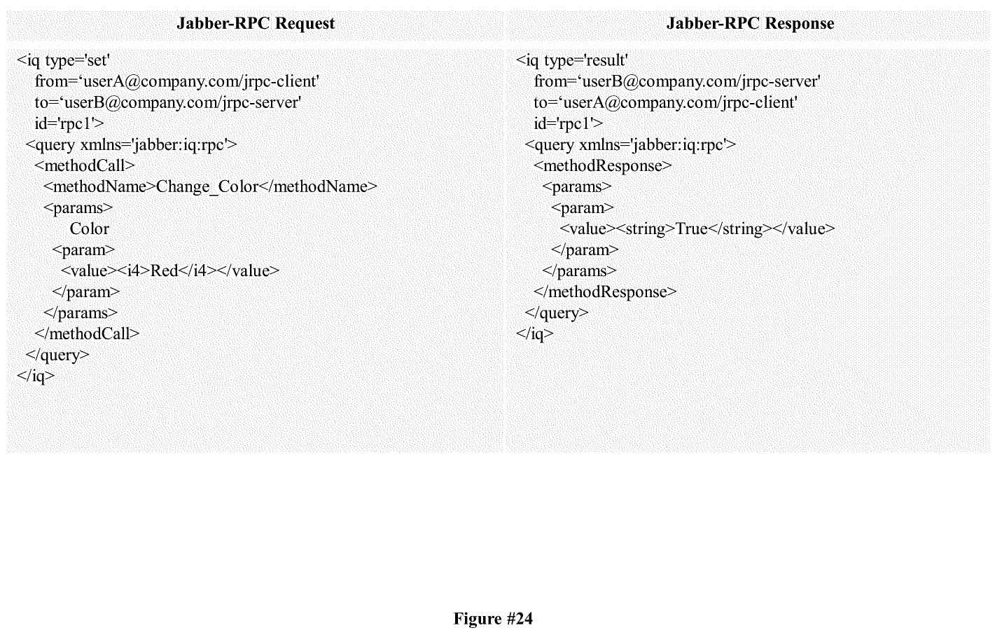

FIG. 23 describes the collaboration through 3D models 2300 wherein wife 2302 and husband 2303 are registered with the XMPP server 2301 and establish a trust mechanism by being “buddies”. In the current session, they 2302 and 2303 are both watching & interacting with a 3D model of a chair. This 3D model is encoded in XML for X3D and JSON for glTF. For instance, if wife 2302 interacts with the GUI wherein she selects the chair and changes the color of the chair. Under solo operation, the color of the chair is changed and the operation ends whereas in a Collaborative session, every action done locally a corresponding change happens at the other end i.e. at husband's “as “3D model” as well. In the same operation, when Wife 2302 issues a color change command via the GUI, a method call is generated which is encoded in Jabber-RPC and routed to husband 2303 who has a trust-relationship established a-priori. This causes husband's chair model also to have the changed color.

FIG. 24 describes a typical “method” encoded in Jabber-rpc as a request. In this case the method is “change_color( )”. Encoding is in XML. The response comes back in Jabber-rpc formatted XML encoding. In this case a “true” value.

Myspace3D Module:

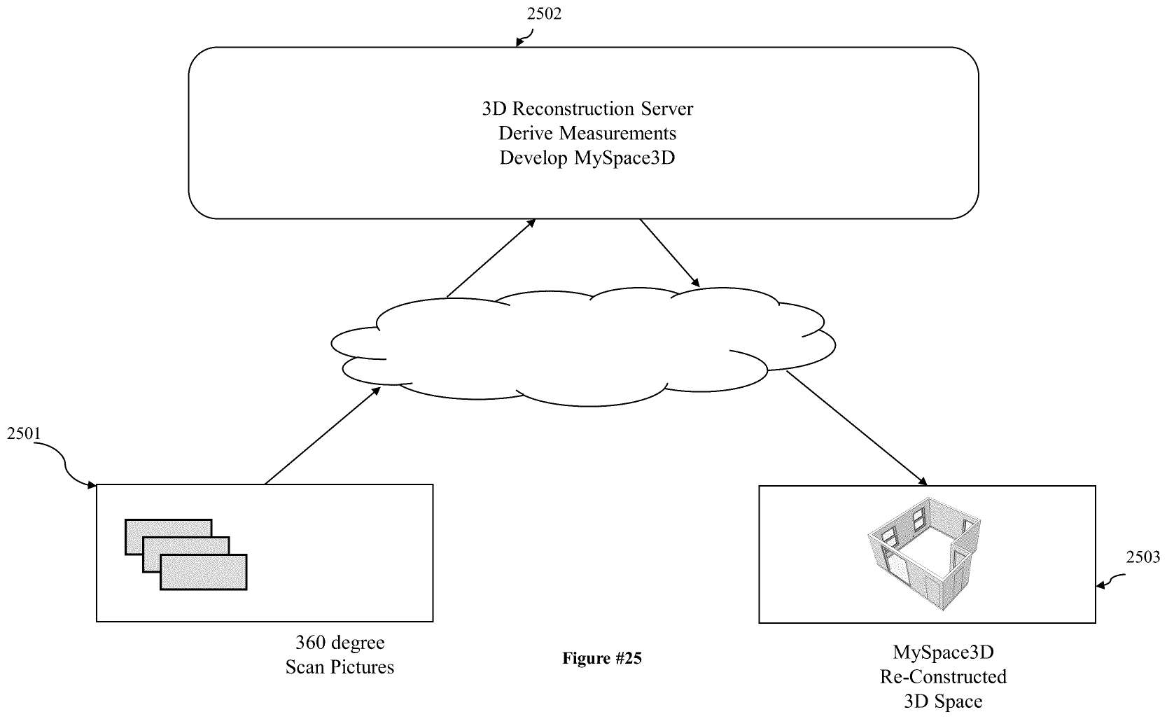

FIG. 25 describes a scheme where the “user” takes pictures of their space such as their “living room” 2501. These pictures should be for all 360 degrees with an overlap between any two consecutive pictures. These pictures can be taken by a camera in a smartphone, a DSLR camera, a LIDAR based camera such as the iPAD pro from Apple or any TOF (Time of Flight) sensor based camera. These pictures are uploaded to the re-construction server 2502 where a 3D model is re-created using computer-vision algorithms. This 3D model is scale-accurate with measurements of “length”, “width”, “curvature” etc. derived from the pictures. Textures and colors are also extracted from the pictures into the 3D model. This 3D model is then imported into a 3D engine such as Unity and made available to the end-user as an App 2503 where they could perform composition from the 3D enabled store as described in the composition module. These “spaces” could be “residential”, “commercial”, “indoor”, “outdoor” etc.

References for Technologies, Protocols, Formats, Products

model-viewer
https://modelviewer.dev/
model-viewer is an html tag/web-component that is powered by a JavaScript based engine named model-viewer.js that can render glTF models.
It has been developed by Google.

threejs
https://threejs.org/
threejs is an open-source Javascript library that can render many 3D formats including glTF that is used in this patent application.

glTF
https://www.khronos.org/gltf/
Specification—https://github.com/KhronosGroup/glTF/tree/master/specification/2.0
Material Properties https://github.com/KhronosGroup/glTF/tree/master/specification/2.0 #metallic-roughness-material
Lights—https://github.com/KhronosGroup/glTF/tree/master/extensions/2.0/Khronos/KHR_lights_punctual
Graphics Library Transmission Format is a file format for 3D scenes and models using the JSON standard

X3D
https://www.web3d.org/
https://www.web3d.org/documents/specifications/19775-1/V3.2/Part01/Architecture.html
Extensible 3D (X3D) Graphics is the royalty-free open standard for publishing, viewing, printing and archiving interactive 3D models on the Web. File format is XML, binary etc.

Unity
https://unity.com/
Platform for development of 2D, 3D, AR, VR Applications.

PBR
An approach to model materials and render 3D scenes that bring about photo-realism and adheres to laws of Physics
https://en.wikipedia.org/wiki/Physically_based_rendering

Shaders

Special programs written in a low-level language that define how a specific surface interacts with light for photo-realistic effect. Reflection, Refraction, Absorption from primary light and ambient-light are defined among others. Real world objects such as “Steel”, “Wood”, “Leather” get a realistic appearance due to them.
HLSL https://en.wikipedia.org/wiki/High-Level_Shading_Language
GLSL https://en.wikipedia.org/wiki/OpenGL_Shading_Language

WebRTC
https://webrtc.org/
WebRTC (Web Real-Time Communication) is a free, open-source project that provides web browsers and mobile applications with real-time communication (RTC) via simple application programming interfaces (APIs). Supports Audio, Video & data. WebRTC is being standardized through the W3C & IETF
Jitsi.org

XMPP
https://xmpp.org/
Jabber-RPC—https://xmpp.org/extensions/xep-0009.html
Extensible Messaging and Presence Protocol (XMPP) is a communication protocol for message-oriented middleware based on XML (Extensible Markup Language). It enables the near-real-time exchange of structured yet extensible data between any two or more network entities. It is an IETF standard

HTTP(S)
https://www.w3.org/Protocols/rfc2616/rfc2616.html
The Hypertext Transfer Protocol (HTTP) is an application protocol for the web. It enables the web-browser and web-server to communicate. It is standardized by W3C and IETF

Database
https://dev.mysql.com/doc/refman/8.0/en/json.html
https://dev.mysql.com/doc/refman/8.0/en/json.html#json-paths
https://www.w3.org/XML/
https://tools.ietf.org/html/rfc7159 (JSON)
XML database to store X3D scenes. Querying is via XQuery
JSON database to store glTF scenes. Querying is via SQL/JSON, Find, XPath etc.

XQuery
https://www.w3.org/XML/Query/
XQuery (XML Query) is a query and functional programming language that queries and transforms collections of structured and unstructured data, usually in the form of XML. Developed by W3C

Video Chat Server
https://jitsi.org/
A server that enables video-chat within a small group of people including video, audio and text-chat sessions.

Implemented via WebRTC, XMPP 3D Collaboration Server
The server in a 3D Collaboration system, that enables 3D Collaboration Clients to visualize, interact with 3D models. The 3D models of interest being in X3D and glTF

eCommerce Server
https://magento.com/
A server that has capabilities of a web-server, payment-gateway, shopping cart etc. to enable online ecommerce via simple web-browsers

DRM
DRM—https://en.wikipedia.org/wiki/Digital_rights_management
RSA—https://en.wikipedia.org/wiki/RSA_(cryptosystem)
X509—https://en.wikipedia.org/wiki/X.509
AES—https://en.wikipedia.org/wiki/Advanced_Encryption_Standard
CA—https://www.digicert.com/

1. A system for evolving e-commerce to the next generation, the system comprising:
a. an input module, enabled to receive a query-based input from a buyer related to each of plurality of purchase item of at least one seller;
b. a processing module, enabled to search the received query-based input related to each of plurality of purchase item and determine a 3D model of each of plurality of purchase item;
c. a 3D model driven query-based database module, enabled to store and query the determined 3D model of each of the plurality of purchase item;
d. a digital rights management module, enabled to protect and control usage of 3D assets via cryptography and license management;
e. a composition module, enabled to compose a 3D model of a space with each of the plurality of 3D model of the purchase item;
f. a configuration module, enabled to customize at least one attribute of each of the plurality of 3D model of the purchase item or 3D model of the space by a 3D input; and
g. a collaboration module enabled to facilitate the collaboration of 3D models between the buyer and the at least one seller in real time along with video collaboration and chat.

2. The system of claim 1, wherein the query-based input includes textual inputs, image-based input and 3D model-based input.

3. The system of claim 1, wherein the 3D model of the space is at least one of a housing, kitchen, living room, a residential area, business area, open area, business room, garden area, photographs, or any combination thereof.

4. The system of claim 1, wherein devices like “Personal Computers”, “Smartphones”, “Tablets” and the “Web as Application platform” are supported.

5. The system of claim 1, wherein the processing module crawls the plurality of e-commerce sites hosting 3D models and indexes them in the 3D model driven query-based database module aiding in query-based textual and 3D model driven searches with query results showing URL's of eCommerce sites satisfying query inputs.

6. The system of claim 1, wherein the digital rights management module authenticates users cryptographically including using digital certificates, a combination of symmetric, asymmetric cryptography and licensing techniques to protect and control usage of 3D assets.

7. The system of claim 1, wherein it includes a reconstruction module to generate 3D models in a work-flow pipeline including computer-vision based mesh-reconstruction, adjustment of materials, compression of “mesh” and “materials”.

8. The system of claim 1, wherein the composition module enables the buyer to add, delete and modify a 3D-model or artefact like images from the at least one ecommerce site using techniques such as “drag-drop”, “point-click” and “cut-paste”.

9. The system of claim 1 wherein the collaboration module enables interaction between the buyer and at least one seller in real time via text, audio, video, visual indication, 3D models or any combination thereof.

10. The system of claim 1, wherein the customization of the at least one attribute of the purchase item is visible to a plurality of co-participants connected via internet.

11. The system of claim 1, wherein the customization of the at least one attribute of the purchase item is configured by the buyer in “solo” or in collaboration with the plurality of co-participants connected via internet.

12. The system of claim 1, wherein the user uploads pictures of his space and the system re-constructs a 3D digital-twin named MySpace3D or eSpace3D or equivalent using computer-vision algorithms enabling the user to composite MySpace3D using the composition module.

13. A method for evolving e-commerce to the next generation, the method comprising the steps of:
a. receiving a query-based input, from a buyer, related to each of plurality of purchase item of at least one seller;
b. processing the received query-based input to determine a 3D model of each of plurality of purchase item;
c. storing and querying the determined 3D model of each of the plurality of purchase item;
d. protecting and controlling usage of 3D assets via cryptography and license management;
e. composing a 3D model of a space with each of the plurality of 3D model of the purchase item;
f. customizing at least one attribute of each of the plurality of 3D model of the purchase item or 3D model of the space by a 3D input; and
g. facilitating the communication and collaboration of 3D models between the buyer and the at least one seller in real time along with video collaboration and chat.

14. The method of claim 12, wherein the query-based input includes textual inputs, query based input, image based input and 3D model based input.

15. The method of claim 12, wherein the 3D model of the space is at least one of a housing, kitchen, living room, a residential area, business area, open area, business room, garden area, photographs, or any combination thereof.

16. The method of claim 12, wherein devices like “Personal Computers”, “Smartphones”, “Tablets” and the “Web as Application Platform” are supported.

17. The method of claim 12, wherein processing further includes crawling the plurality of e-commerce sites hosting 3D models and indexing them in the 3D model driven query-based database module aiding in query-based textual and 3D model driven searches with query results showing URL's of e-commerce sites satisfying query inputs.

18. The method of claim 12, wherein protecting and controlling usage of 3D assets further includes authenticating users cryptographically via using digital certificates, a combination of symmetric, asymmetric cryptography and licensing techniques.

19. The method of claim 12, wherein it further includes reconstructing 3D models in a work-flow pipeline including computer-vision based mesh-reconstruction, adjustment of materials, compression of “mesh” and “materials”.

20. The method of claim 12, wherein the composing enables the buyer to add, delete and modify a 3D-model or artefact like images from the at least one ecommerce site using techniques such as “drag-drop”, “point-click” and “cut-paste”.

21. The method of claim 12, wherein the collaboration includes interaction between the buyer and the at least one seller in real time via text, audio, video, visual indication, 3D models or any combination thereof.

22. The method of claim 12, wherein the customization of the at least one attribute of the purchase item is visible to a plurality of co-participants connected via internet.

23. The method of claim 12, wherein the customization of the at least one attribute of the purchase item is configured by the buyer in solo or in collaboration with the plurality of co-participants connected via internet.

24. The method of claim 12, wherein the user uploads pictures of his space and the system re-constructs a 3D digital-twin named MySpace3D or eSpace3D or equivalent using computer-vision algorithms enabling the user to composite MySpace3D using the composition module.
